(19) United States
(12) Patent Application Publication
(10) Pub. No.: US 2018/0367822 A1
(43) Pub. Date: Dec. 20, 2018

(54) ABR STREAMING OF PANORAMIC VIDEO

(71) Applicant: Cisco Technology, Inc., San Jose, CA (US)

(72) Inventors: Yoav GLAZNER, Beit Shemesh (IL); Amitay Stern, Jerusalem (IL)

(21) Appl. No.: 15/626,131

(22) Filed: Jun. 18, 2017

(51) Int. Cl. H04N 21/218; H04L 29/06; H04N 19/23; H04N 21/4728; H04N 21/845

(52) U.S. Cl. CPC H04N 21/21805; H04L 65/607; H04N 21/845; H04N 19/23; H04N 21/4728; H04L 65/4084

(57) ABSTRACT

In one embodiment, a method includes storing data used by a processor, and selecting different bitrates for streaming of a plurality of picture part streams of a video content item to a client device based on available bandwidth and historic data of how much at least one region of a plurality of pictures of the video content item has been rendered for viewing during rendering of the video content item by the client device, wherein each one picture part stream of the plurality of picture part streams conveys a different part of each one picture of the plurality of pictures, and is encoded at a plurality of bitrates. Related apparatus and methods are also described.

### TECHNICAL FIELD

The present disclosure generally relates to streaming of panoramic video.

### BACKGROUND

Panoramic videos include 360-degree videos, also known as immersive videos or spherical videos, and are generally video recordings where a view in every direction is recorded at the same time, shot using an omnidirectional camera or a collection of cameras. During playback, the viewer has control of the viewing direction like a panorama.

Viewers of panoramic video content typically use a head-mounted display (HMD) to interactively select and present a view of the content. The HIVID presents a view in the form of a “viewport”, a subset of a larger amount of video that is available at a specific point in time in the video content. A viewport is typically a selected region of a larger video image or set of images available for presentation at that time.

Adaptive bitrate streaming is a technique used in streaming multimedia over computer networks. It works by detecting a user's bandwidth and CPU capacity in real time and adjusting the quality of a video stream accordingly. An encoder encodes a single source video at multiple bitrates. The player client switches between streaming the different encodings depending on available resources. The streaming client is made aware of the available streams at differing bitrates, and segments of the streams by a manifest file. When starting, the client requests the segments from the lowest bitrate stream. If the client finds the download speed is greater than the bitrate of the segment downloaded, then it requests the next higher bitrate segments. Later, if the client finds the download speed for a segment is lower than the bitrate for the segment, and therefore the network throughput has deteriorated, the client requests a lower bitrate segment. The control may be server based in some implementations.

### BRIEF DESCRIPTION OF THE DRAWINGS

The present disclosure will be understood and appreciated more fully from the following detailed description, taken in conjunction with the drawings in which:

FIGS. 1A and 1B are views illustrating viewing of a video content item for use in a system constructed and operative in accordance with an embodiment of the present disclosure;

FIGS. 2A-D are views illustrating viewing ratings of regions of a video content item for use in the system of FIG. 1;

FIGS. 3A and 3B are views illustrating picture part streams for use in the system of FIG. 1;

FIG. 4 is a block diagram view of apparatus in the system of FIG. 1;

FIGS. 5-7 are flow charts showing exemplary steps in a method of operation of the apparatus of FIG. 4; and

FIGS. 8-9 are flow charts showing exemplary steps in a method of operation of the apparatus of FIG. 4 in accordance with an alternative embodiment of the present disclosure.

### DESCRIPTION OF EXAMPLE EMBODIMENTS

### Overview

There is provided in accordance with an embodiment of the present disclosure, a method including storing data used by a processor, and selecting different bitrates for streaming of a plurality of picture part streams of a video content item to a client device based on available bandwidth and historic data of how much at least one region of a plurality of pictures of the video content item has been rendered for viewing during rendering of the video content item by the client device, wherein each one picture part stream of the plurality of picture part streams conveys a different part of each one picture of the plurality of pictures, and is encoded at a plurality of bitrates.

### Definitions

The term “encoded” is used throughout the present specification and claims, in all of its grammatical forms, to refer to any type of data stream encoding including, for example and without limiting the scope of the definition, well known types of encoding such as, but not limited to, MPEG-2 encoding, H.264 encoding, VC-1 encoding, and synthetic encodings such as Scalable Vector Graphics (SVG) and LASER (ISO/IEC 14496-20), and so forth. It is appreciated that an encoded data stream generally requires more processing and typically more time to read than a data stream, which is not encoded. Any recipient of encoded data, whether or not the recipient of the encoded data is the intended recipient, is, at least in potential, able to read encoded data without requiring cryptanalysis. It is appreciated that encoding may be performed in several stages and may include a number of different processes, including, but not necessarily limited to: compressing the data; transforming the data into other forms; and making the data more robust (for instance replicating the data or using error correction mechanisms).

The term “compressed” is used throughout the present specification and claims, in all of its grammatical forms, to refer to any type of data stream compression. Compression is typically a part of encoding and may include image compression and motion compensation. Typically, compression of data reduces the number of bits comprising the data. In that compression is a subset of encoding, the terms “encoded” and “compressed”, in all of their grammatical forms, are often used interchangeably throughout the present specification and claims.

Similarly, the terms “decoded” and “decompressed” are used throughout the present specification and claims, in all their grammatical forms, to refer to the reverse of “encoded” and “compressed” in all their grammatical forms.

### DETAILED DESCRIPTION

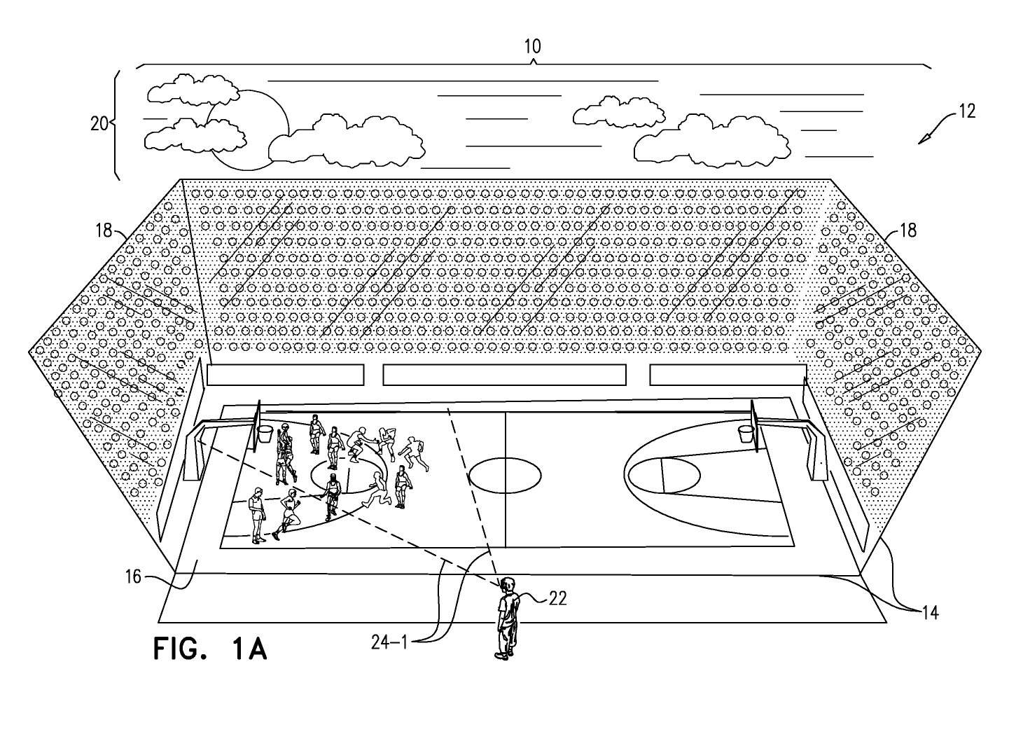

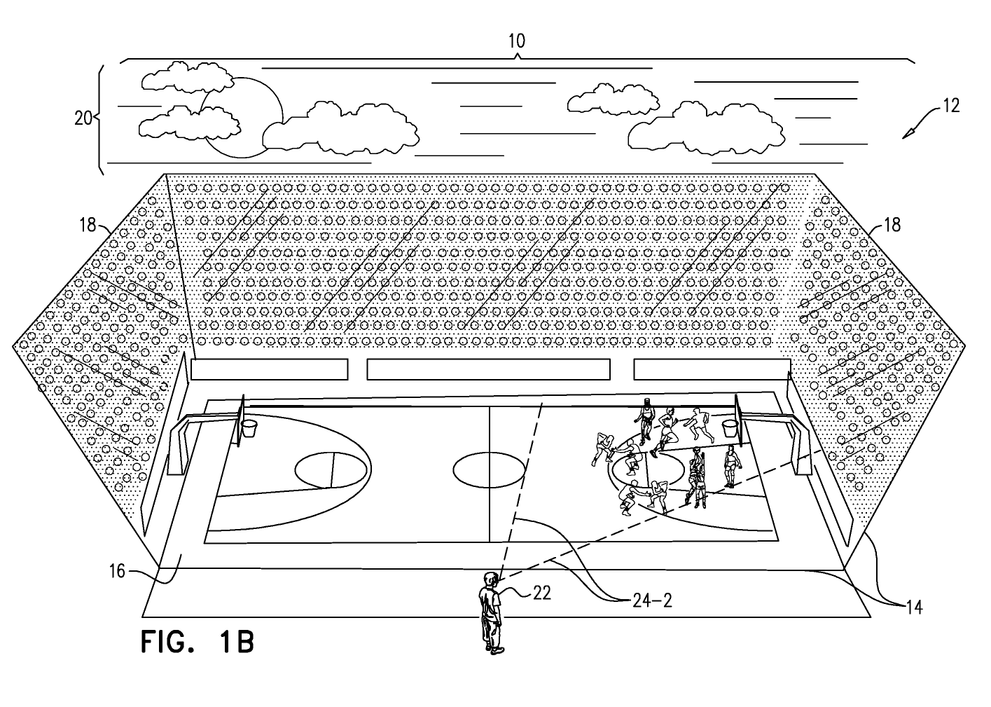

Reference is now made to FIGS. 1A and 1B, which are views illustrating viewing of a video content item 10 for use in a system 12 constructed and operative in accordance with an embodiment of the present disclosure. By way of introduction, panoramic video, including 360-degree video, generally uses significantly more bandwidth, central processing unit (CPU) and caching resources than non-panoramic video of the same video quality. In contrast to non-panoramic video, panoramic video is typically viewed by a viewer via a viewport, which is a sub-picture of a larger picture available at any one time. Therefore, much of the panoramic content, which is streamed, cached, and processed, may not be rendered by a client device. This has been illustrated in FIGS. 1A and 1B, which show a basketball game being played in a stadium 14 including a court 16 and a crowd seating area 18. The video content item 10 also shows a segment of sky 20 above the stadium 14. FIGS. 1A and 1B illustrate that a viewer 22 viewing the video content item 10 based on a camera disposed somewhere above the court 16 will generally be viewing a viewport 24-1, 24-2 of the court 16 and more rarely other areas of the video content item 10. For example, the viewer 22 may look around at the crowd seating area 18 and the segment of sky 20, but this may be a rare occurrence. Additionally, some parts of the court 16 may be viewed more depending on whether the viewer 22 is a fan of the home or away team. FIG. 1A shows the viewport 24-1 of the home team attacking and FIG. 1B shows the viewport 24-2 of the away team attacking. It will be appreciated that the viewport 24 selected by the person 22 depends on personal viewing habits and preferences and differs depending on the type of content being viewed.

It will be appreciated that resources may be wasted if the whole picture of the video content item 10 is streamed to the client device at the same quality. Therefore, the system 12 is operative to arrange streaming of the video content item 10 to the client device taking into account how much a region (or regions) of a plurality of pictures of the video content item 10 has been rendered for viewing during rendering of the video content item 10 by the client device so that different parts of the picture of the video content item 10 are streamed with a different bitrate. Viewing ratings may be determined for the video content item 10, explained in more detail below, based on viewport history data. The viewing ratings may then be used by the system 12 to customize the streaming of the video content item 10 to select different bitrate streams according to the calculated viewing ratings and other factors such as available bandwidth, CPU, and cache capacity.

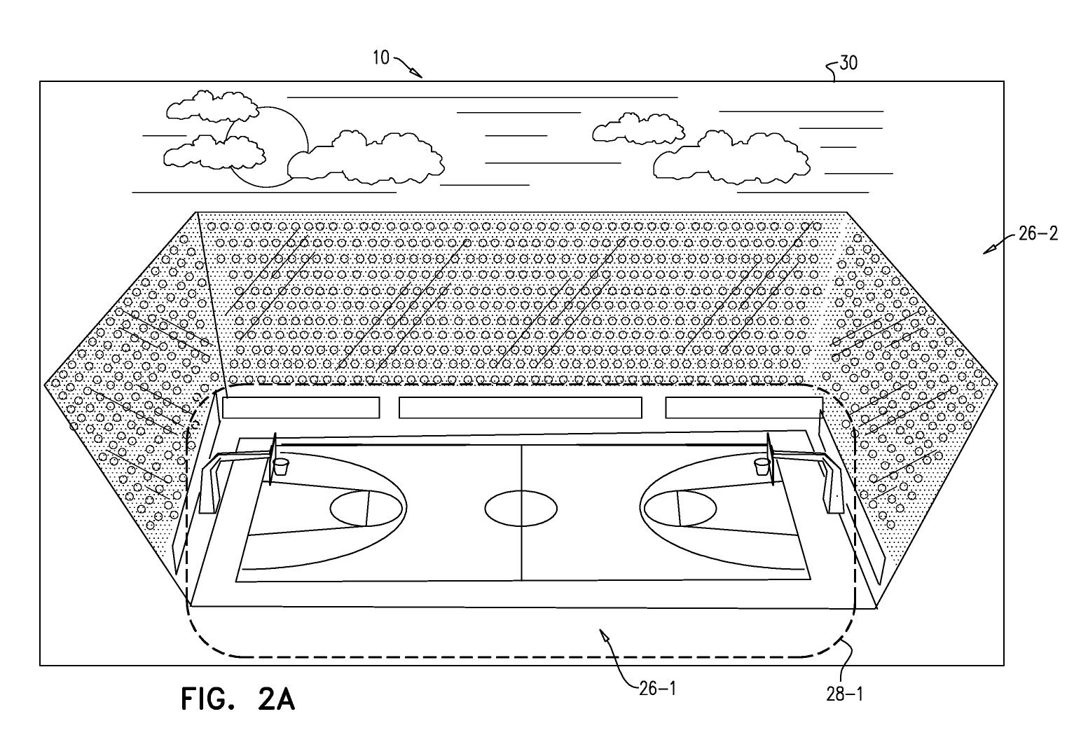

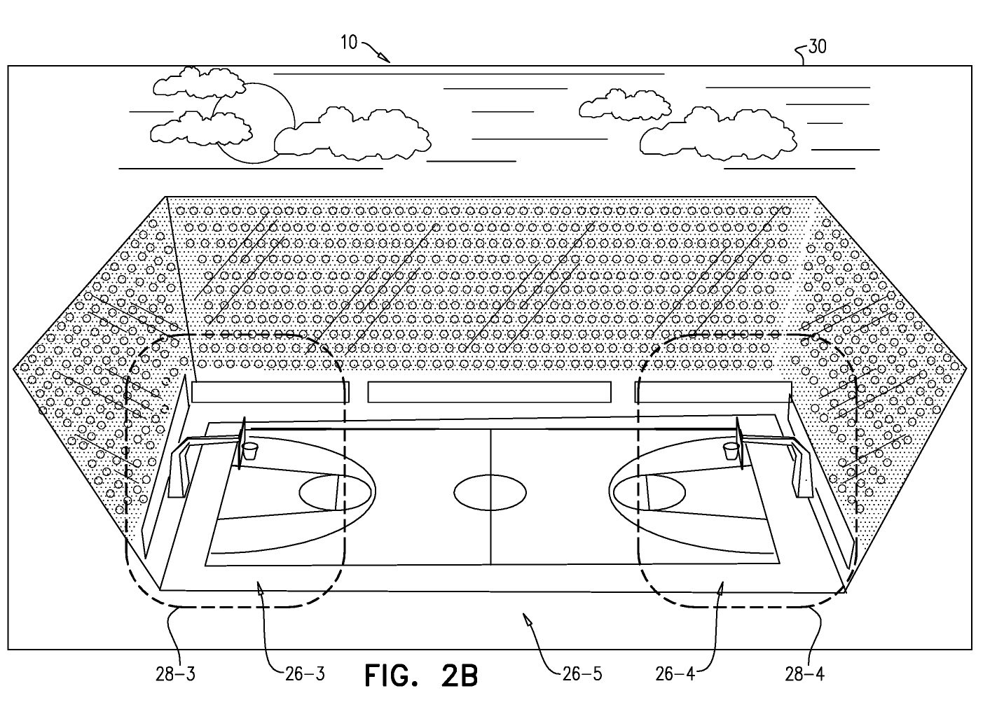

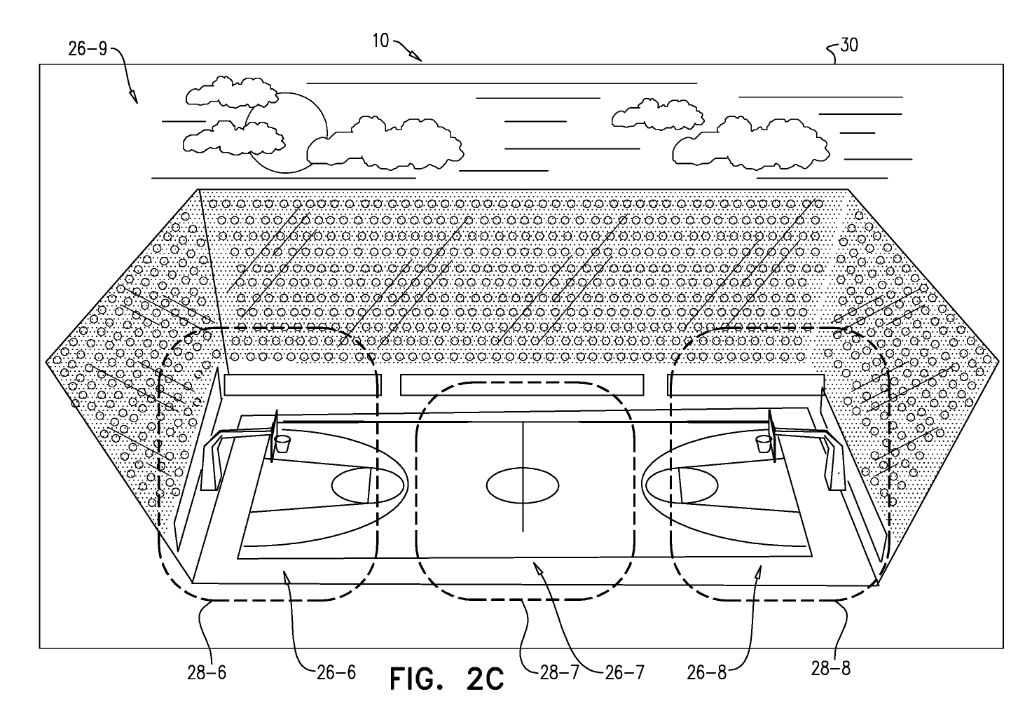

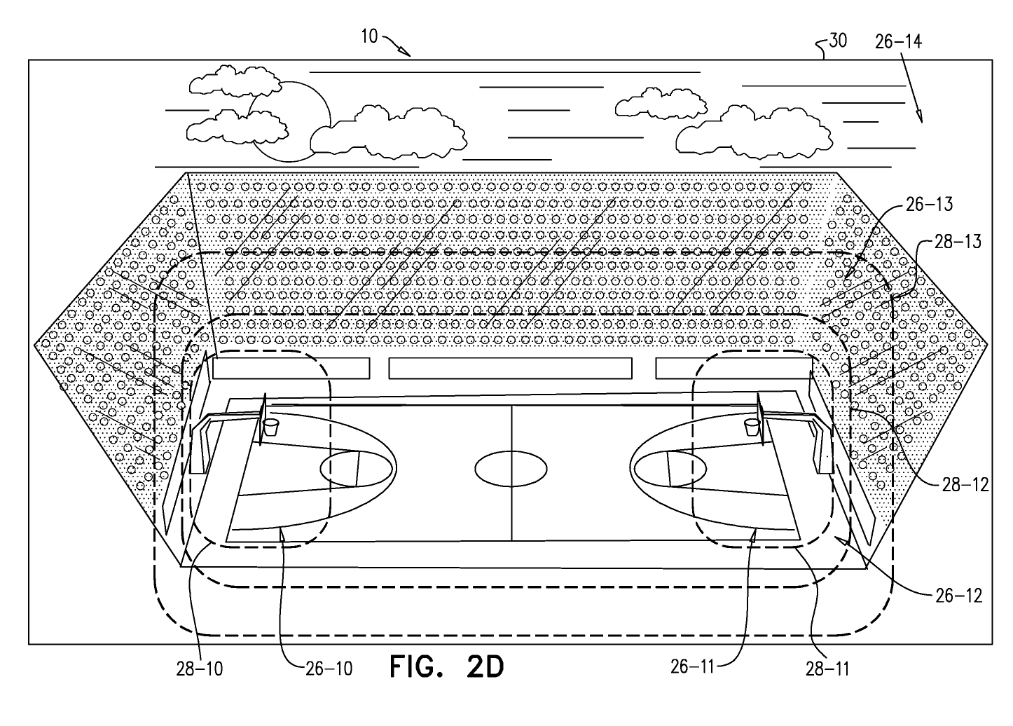

Reference is now made to FIGS. 2A-D, which are views illustrating viewing ratings of regions 26 of the video content item 10 for use in the system 12 of FIG. 1. FIG. 2A shows a region 26-1 inside a dotted line 28-1 that has a higher viewing rating (e.g., viewing rating 1) than a region 26-2 outside of the dotted line 28-1 with a lower viewing rating (e.g., viewing rating 0). A viewing rating may be assigned to a region 26 of a picture 30 of the video content item 10 from which viewport(s) were generated for viewing by the viewer 22 (FIGS. 1A, 1B) and where the viewports exceeded a certain viewing target. For example, the region 26-1 may be associated with a viewing rating 1. The viewing rating 1 may be applied to a region 26 of the picture 30 where viewing (based on viewport(s) generated) exceeds a first viewing target, for example, more than 5 seconds viewing in the region since the start of the rendering of the video content item 10, or more than 3 seconds viewing in the region in the previous 5 minutes of the rendering of the video content item 10, or any viewing in the region since the start of the rendering of the video content item 10, or any viewing in the region in the region in the previous 3 minutes of the rendering of the video content item 10, etc. The region 26-2 may be associated with a viewing rating 0 or no viewing rating. The viewing rating 0 may be applied to a region, which does not exceed the first viewing target.

By way of another example, it is possible, that the viewing rating 0 may be applied to a region (e.g., the region 26-2) that exceeds the first viewing target and viewing rating 1 may be applied to a region that exceeds a second viewing target (which is greater than the first viewing target). It will be appreciated that in this example (based on FIG. 2A) the whole picture 30 had been subject to viewport generation at least some time during the rendering of the video content item 10 by the client device, which is possible, although unlikely.

According to a configuration of the system 12, it will be appreciated that there may be two or more available viewing ratings associated with one or more viewing targets. For example, three viewing ratings may be based on two or three viewing targets.

Based on the viewing ratings and other factors (such as available bandwidth, CPU, and cache capacity), the system 12 is operative to select different bitrate streams. This may be illustrated by way of an example. Assume that the streams are available at 5 bitrates (bitrate 1, bitrate 2 etc., where bitrate 1 is the lowest available bitrate). Subject to the other factors (such as available bandwidth, CPU and cache capacity), the system 12 may select streaming of the parts of the pictures 30 of the video content item 10 including the region 26-1 at bitrate 5 and all other parts of the pictures 30 at bitrate 4. If the proposed selected bitrates are too high based on the other factors (e.g., not enough bandwidth), then the system 12 may select bitrate 4 for the parts of the pictures 30 of the video content item 10 including the region 26-1, and all other parts of the pictures 30 at bitrate 3. Another alternative may be to select bitrate 5 for the parts of the pictures 30 of the video content item 10 including the region 26-1, and all other parts of the pictures 30 at bitrate 2. If the above-proposed bitrates are too high based on the other factors then lower bitrates may then be selected. It will be appreciated that different combinations and permutations of the bitrates may be considered based on the other factors, but in general the bitrate selected for the parts of the pictures 30 of the video content item 10 including the region 26-1 is higher than the bitrate selected for all other parts of the picture 30.

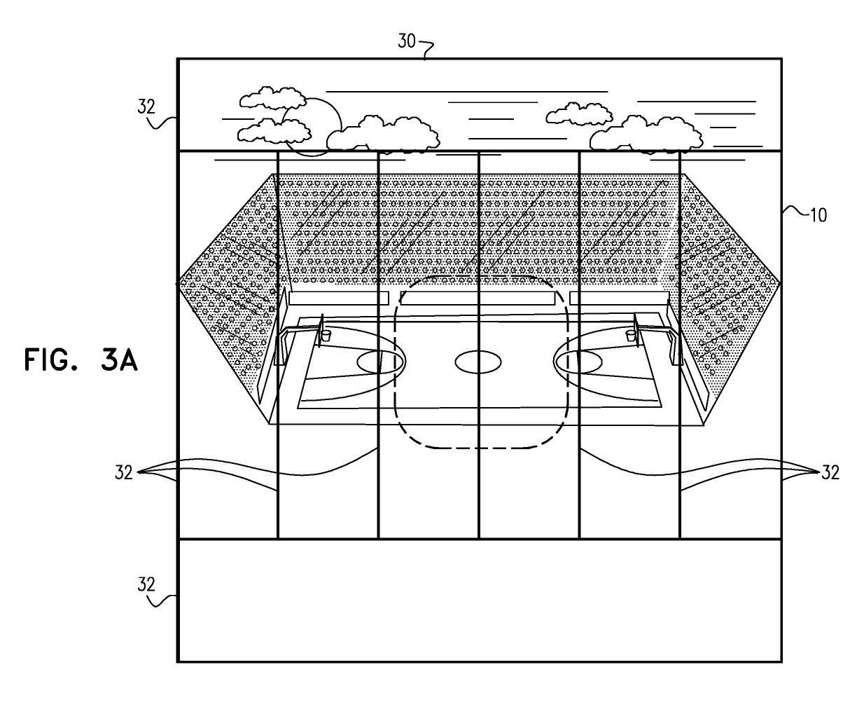

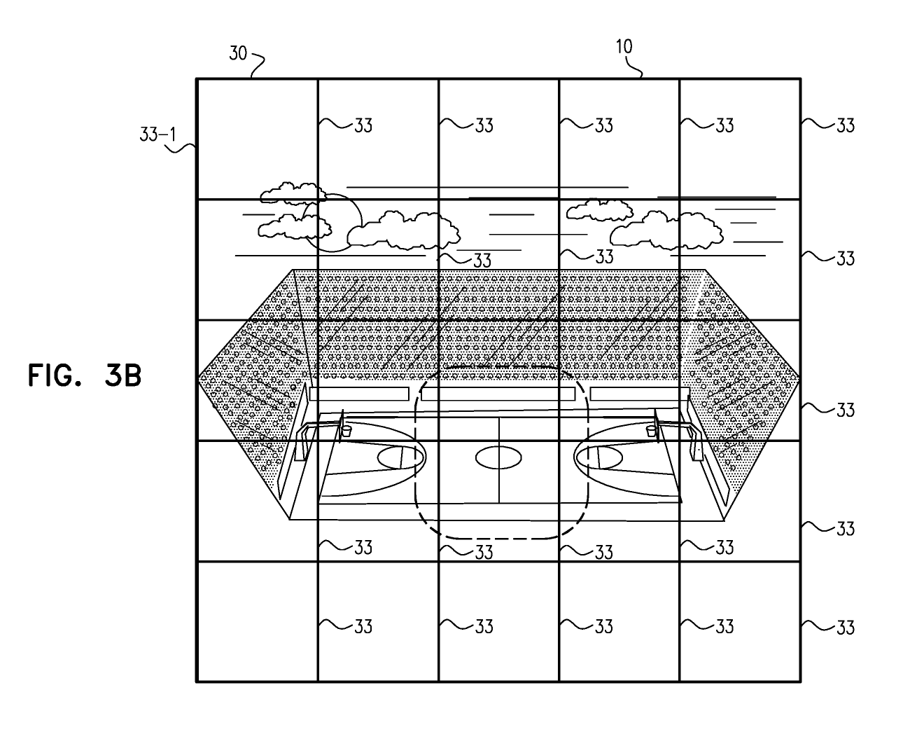

Dividing the pictures 30 into different streams is discussed in more detail with reference to FIGS. 3A and 3B, but at this point it will be appreciated that the pictures 30 are typically divided according to a certain scheme and the pictures 30 are generally not divided according to the regions 26 as the regions 26 are generally dynamically changed throughout rendering of the video content item 10. Therefore, the system 12 generally makes a determination regarding streams, which include two or more regions of different viewing ratings. One method is to select a bitrate for a stream including two or more regions according to the viewing rating of the region with the highest viewing rating. Another method is to select a bitrate for a stream including two or more regions according to the viewing rating of the region with the lowest viewing rating. Another method is to select a bitrate for a stream including two or more regions according to the viewing rating of the largest region included in that stream. Another method is to select a bitrate for a stream including two or more regions according to an average viewing rating of the different regions included in that stream. The average may or may not be weighted according to a size of each of the regions included in that stream.

FIG. 2B shows three regions 26. A region 26-3 is inside a dotted line 28-3 and a region 26-4 is inside a dotted line 28-4. A region 26-5 is disposed externally to both region 26-3 and region 26-4. Depending on the viewports generated and how the viewing rating limits have been defined, regions 26-3 and 26-4 may have the same viewing rating associated with exceeding a viewing target whereas region 26-5 may be associated with not exceeding that viewing target or exceeding a different viewing target. Alternatively, depending on viewports generated and how the viewing rating limits have been defined, regions 26-3 and 26-4 may have different viewing ratings associated with exceeding different viewing targets.

It will be appreciated that when the regions 26-3 and 26-4 have the same viewing rating, the system 12 may select the same bitrate for streams (subject to the discussion above related to dividing the pictures 30 into different streams) associated with the regions 26-3 and 26-4 and a different, typically lower, bitrate for the streams associated with the region 26-5 according to the other factors (such as available bandwidth, CPU and cache capacity) mentioned above with reference to FIG. 2A. When the regions 26-3 and 26-4 have different viewing ratings, the system 12 may select different bitrate for streams (subject to the discussion above related to dividing the pictures 30 into different streams) associated with the regions 26-3 and 26-4 according to the viewing ratings of the regions 26-3 and 26-4 and another different, typically lower, bitrate for the streams associated with the region 26-5 according to the other factors (such as available bandwidth, CPU and cache capacity) mentioned above with reference to FIG. 2A.

FIG. 2C shows three regions 26. A region 26-6 is inside a dotted line 28-6, region 26-7 is inside a dotted line 28-7, region 26-8 is inside a dotted line 28-8, and a region 26-9 is outside the regions 26-6, 26-7, 26-8. It will be appreciated that depending on viewports generated and how the viewing rating limits have been defined, all three regions 26-6, 26-7, 26-8 may have the same viewing rating, two of the three regions 26-6, 26-7, 26-8 may have the same viewing rating, or all three regions 26-6, 26-7, 26-8 may have different viewing ratings. By way of example, when all three regions 26-6, 26-7, 26-8 have different viewing ratings, different bitrate streams may be selected for the streams associated with the different regions 26-6, 26-7, 26-8, 26-9. It will be appreciated that in some embodiments, the same bitrate for the streams may be selected for different regions 26 with different viewing ratings, for example, based on the other factors.

FIG. 2D shows five regions 26-10, 26-11, 26-12, 26-13, and 26-14. Regions 26-10 and 26-11 are inside dotted lines 28-10 and 28-11, respectively. Region 26-12 is bounded by a dotted line 28-12 and dotted lines 28-10 and 28-11. Region 26-13 is bounded by the dotted line 28-12 and a dotted line 28-13. Region 26-14 is outside of dotted line 28-13. It will be appreciated the regions 26-10, 26-11, 26-12, 26-13 and 26-14 may have any suitable viewing rating depending on viewports generated and how the viewing rating limits have been defined.

Reference is now made to FIGS. 3A and 3B, which are views illustrating picture part streams 32 for use in the system 12 of FIG. 1. As briefly described above, the system 12 is operative to provide multiple streams 32 for different parts of the pictures 30 making up the video content item 10. The streams 32 are referred to herein as picture part streams 32 as each stream 32 conveys a different part of the pictures 30 of the video content item 10. Each of the picture part streams 32 are then encoded at multiple bitrates for selection of one of the bitrates per picture part stream 32 based on the viewing ratings and the other factors as described above with reference to FIG. 2A.

FIG. 3A shows eight picture part streams 32, each stream 32 being from a different camera view captured during filming of the video content item 10. The number of picture part streams 32 in the example of FIG. 3A typically depends on the camera configuration used to film the video content item 10.

FIG. 3B shows one of the pictures 30 formatted as an equirectangular representation formed by stitching together the different camera views captured during filming of the video content item 10 and then formatting the stitched picture as an equirectangular representation. Each picture 30 of the video content item 10 is divided into tiles 33. For each tile location, the tiles corresponding to a same location in the pictures 30 are used to form one of the picture part streams. So for example, one picture part stream may be generated from a part of each picture 30 so that the picture part stream includes the image included in the tile 33-1 (in the top left hand corner) of each picture 30 and other picture part streams will correspond to other tiles 33 in the picture 30. It will be appreciated that other representations may be used including a cubemap representation as in known in the art of 360-degree videos.

Reference is now made to FIG. 4, which is a block diagram view of apparatus in the system 12 of FIG. 1. The system 12 includes a server 34, a server 36, and a plurality of client devices 38 (only one shown for the sake of simplicity).

The server 34 may form part of a content provider for providing media content. The server 34 includes a video encoder 40 and optionally a video processor 42 among other processing and storage devices (not shown).

The server 36 may be implemented as part of a content distribution network (CDN) which may include one or more request routers, edge caches and orchestration functions (not shown). The server 36 includes a processor 44, a memory 46, and an interface 48. The memory 46 is operative to store data used by the processor 44. The server 34 and the server 36 may be implemented as separate devices or as an integrated device (indicated by a box 37 with a dotted line).

Each client device 38 includes a processor 50, an interface 52, and a memory 54. The memory 54 is operative to store data used by the processor 50. The processor 50 is operative to run a media player 56, which renders the video content item 10 on a display device 58 and receives user input from a user input device 60. The display device 58 and the user input device 60 may optionally be included in the client device 38. The user input typically relates to viewport selection based on panning movements and optionally focusing in and out. The display device 58 and the user input device 60 may be implemented as a single device for example, but not limited to, a head-mounted display (HIVID) to interactively select and present views of the video content item 10. Alternatively, the display device 58 may be implemented as a computer monitor or similar display device, and the user input device 60 may be implemented as a joystick, mouse, or gesture feedback device, by way of example only.

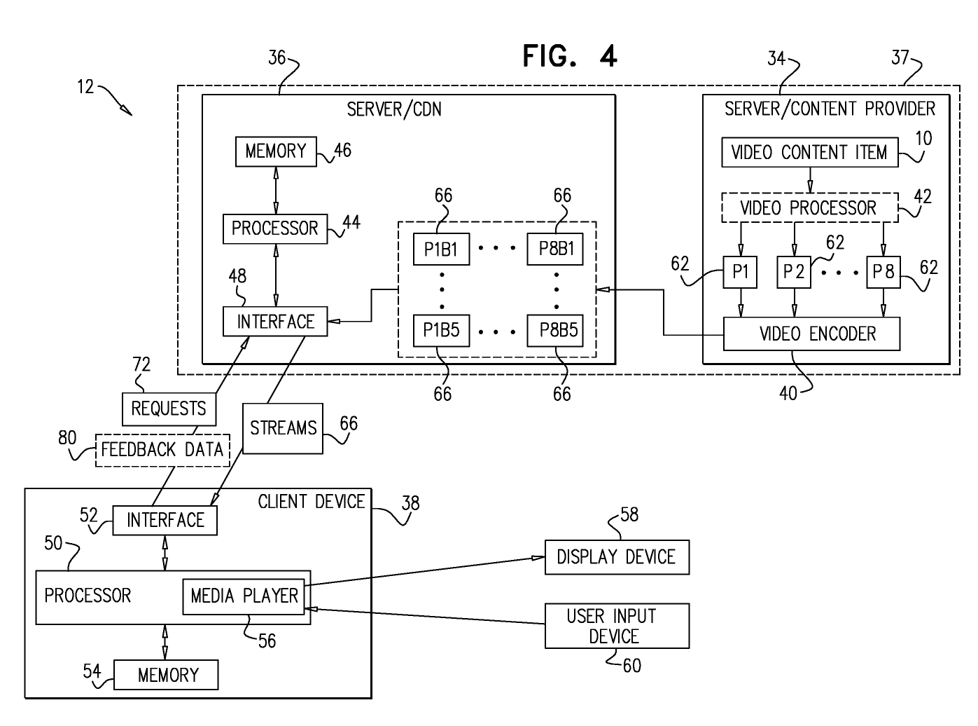

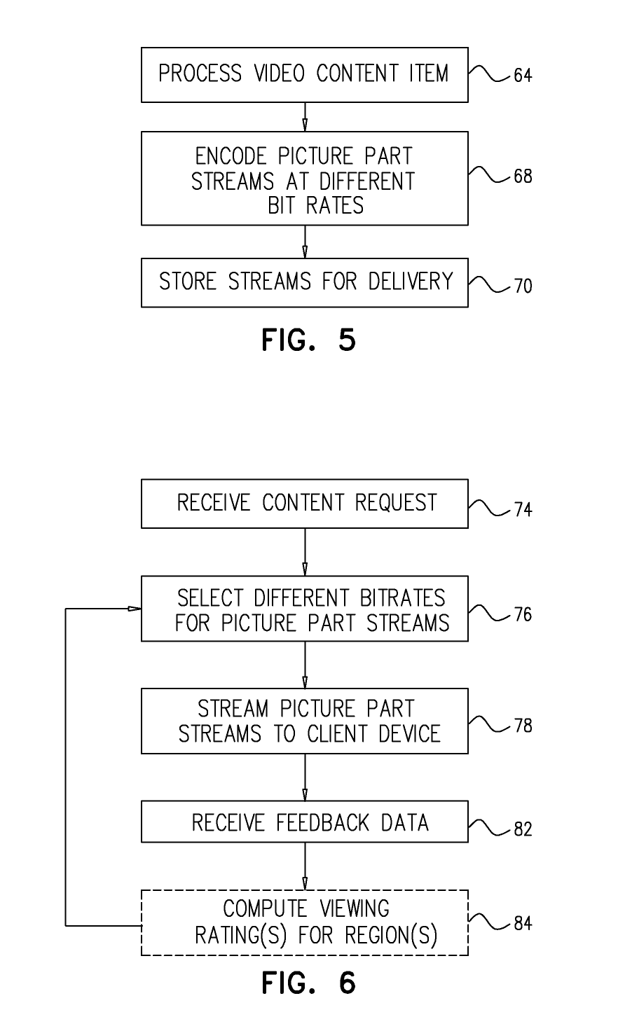

Reference is now made to FIG. 5 which is a flow chart showing exemplary steps in a method of operation of the server 34 of FIG. 4. Reference is also made to FIG. 4. The video content item 10 may be a panoramic video such as a 360-degree video or any suitable video from which viewports may be rendered therefrom. If the video content item 10 is not broken down into a plurality of picture part streams, such as when each picture 30 (FIGS. 2A-D, 3A-B) is comprised in a video frame formatted as an equirectangular representation or a cubemap representation or any suitable representation, the video processor 42 is operative to break down the video content item 10 into a plurality of picture part streams 62 (block 64). If the video content item 10 was previously broken down into the plurality of picture part streams 62, such as when each different picture part stream 62 is from a different camera view captured during filming of the video content item 10, the processing of the step of block 64 is generally not performed. The video encoder 40 is operative to encode, each picture part stream 62 of the video content item 10 at the plurality of bitrates yielding a plurality of encoded picture part streams 66 (block 68). Each encoded picture part stream 66 conveys a different part of each picture 30 and is encoded at a plurality of bitrates. The encoded picture part streams 66 may be stored for delivery, either in the server 34, or in the server 36 (block 70).

Reference is now made to FIG. 6 which is a flow chart showing exemplary steps in a method of operation of the server 36 of FIG. 4. Reference is also made to FIG. 4. The interface 48 of the server 36 is operative to receive a content request 72 from the client device 38 (block 74). The content request 72 is passed by the interface 48 to the processor 44 of the server 36. The processor 44 is operative to select bitrates (optionally different bitrates) for the encoded picture part streams 66 of the video content item 10 which was requested by the client device 38 (block 76). At this stage, as the server 36 has not received any rendering feedback from the client device 38 (as rendering of the video content item 10 has not commenced on the client device 38), the processor 44 is operative to select the bitrates for the encoded picture part streams 66 according to which encoded picture part streams 66 are generally more viewed by other client devices 38 (e.g., based on historic data) or to select the bitrates for the encoded picture part streams 66 at the same bit rate, which may be the lowest bitrate by way of example only. The interface 48 is operative to stream chunks of the encoded picture part streams 66 to the client device 38 (block 78).

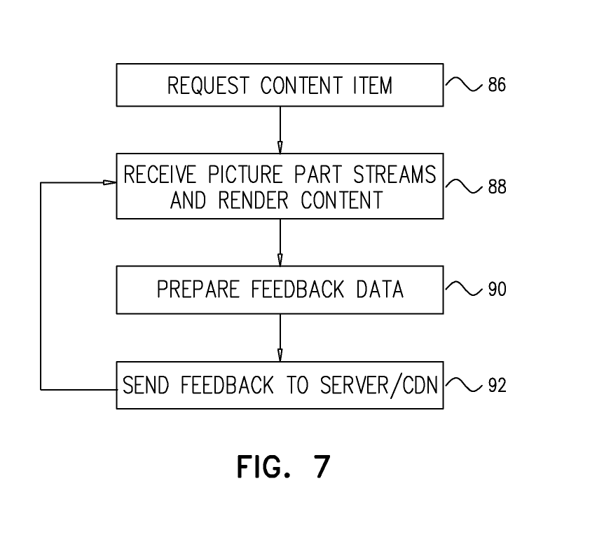

As the video content item 10 is rendered by the client device 38, the client device 38 prepares feedback data 80, described in more detail below with reference to FIG. 7, for sending to the server 36. The feedback data 80 may be sent by the client device 38 to the server 36 periodically as new data becomes available or after a certain time period. The interface 48 is operative to receive the feedback data 80 from the client device 38 rendering the video content item 10 (block 82). The feedback data includes data about a plurality of viewports generated during the rendering of the video content item by the client device. The data about the viewports may include position data of the viewports generated and the time period(s) that the viewports were rendered. Alternatively, the data about the viewports may include a viewing rating(s) for one or more regions of the pictures 30 of the video content item 10 and position data of the region(s). The position data of a region or regions may be expressed in terms of the encoded picture part stream(s) 66, which include the region or regions. The viewports generated during the rendering of the video content item 10 by the client device 38 correspond to the at least one region of the pictures 30 of the video content item 10.

If the feedback data 80 does not include the viewing rating(s), the feedback data 80 may be processed to compute the viewing rating for one or more regions as described above with reference to FIGS. 2A-D (block 84). In other words, if the viewing ratings are not calculated by the client device 38, the viewing ratings are calculated by the server 36. The feedback data may provide, or may be processed to provide, a viewing rating for each at least one region, of how much each at least one region has been rendered for viewing during rendering of the video content item 10 by the client device 38 based on the data about the viewports generated during the rendering of the video content item 10 by the client device 38. The viewing rating of a region may be assigned from a selection of viewing ratings based on whether or not the viewing of the region has exceeded predefined viewing targets, which may be as small as a fraction of a second, or a single video frame duration. In some embodiments, a single viewing rating may be used which is assigned if a predefined viewing target is exceeded which may be as small as a fraction of a second or a single video frame duration. The viewing rating for a region may be based on how much (which may be measured in seconds or frames) the region has been rendered for viewing during a pre-defined duration time period (for example, the last 5 minutes) during rendering of the video content item 10 by the client device 38.

Processing then loops back to the step of block 76, where the processor 44 is operative to select different bitrates for streaming of the encoded picture part streams 66 of the video content item 10 to the client device 38 based on available bandwidth (and optionally other factors including CPU and cache considerations) and the viewing rating(s) based on the feedback data 80 (which includes historic data of how much at least one region of the pictures 30 of the video content item 10 has been rendered for viewing during rendering of the video content item 10 by the client device 38). The processor is operative to select the different bitrates for streaming of the encoded picture part streams 66 so that higher bitrates are selected for higher viewed streams 66 during rendering of the video content item 10 by the client device 38. The interface 48 is operative to stream the encoded picture part streams 66 of the video content item 10 at the selected different bitrates to the client device 38.

Reference is now made to FIG. 7 which is a flow chart showing exemplary steps in a method of operation of the client device 38 of FIG. 4. Reference is also made to FIG. 4. The interface 52 of the client device 38 is operative to send the content request 72 to the server 36 (block 86). The interface 52 is operative to receive the encoded picture part streams 66 and start rendering the video content item 10 (block 88). The processor 50 is operative to prepare the feedback data 80, which may also include computing the viewing rating(s) for the region(s) (block 90). The interface 52 is operative to send the feedback data 80 to the server 36 (block 92). The process continues loops back to the step of block 88 where the interface 52 is operative to receive the encoded picture part streams 66 of the video content item 10 now at the selected different bitrates. It should be noted that there might be a small delay between sending the feedback data 80 to the server 36 and receiving updated selected encoded picture part streams 66 according to the new feedback data 80 due to processing delays in the server 36.

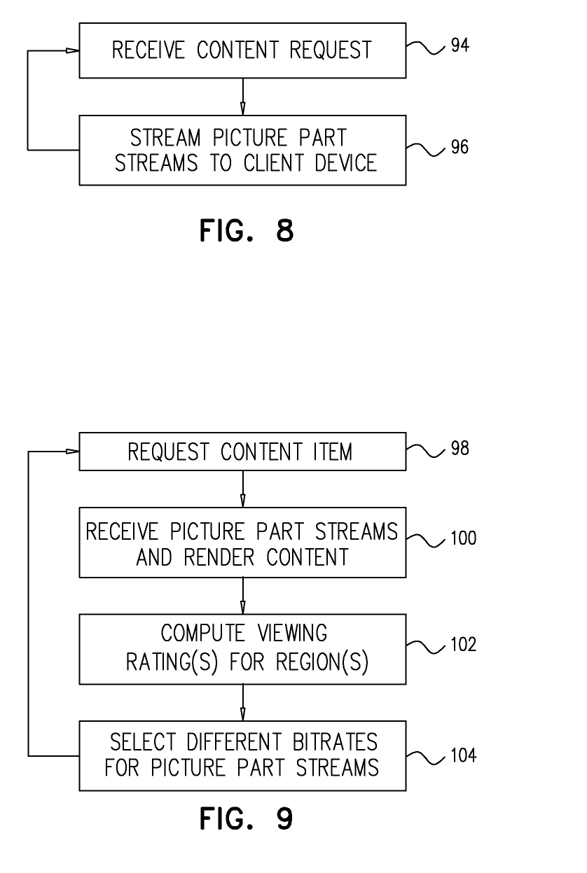

FIG. 8 is a flow chart showing exemplary steps in a method of operation of the server 36 of FIG. 4 in accordance with an alternative embodiment of the present disclosure. Reference is also made to FIG. 4. In accordance with this alternative embodiment, the processor 50 of the client device 38 selects the bitrates of the encoded picture part streams 66.

The interface 48 of the server 36 receives the request 72 for the encoded picture part streams 66 (block 94) according to the bitrates of the encoded picture part streams 66 selected by the client device 38. The interface 48 is operative to stream the picture part streams 66 of the video content item 10 at the selected different bitrates to the client device 38 (block 96). The method continues with the step of block 94 where the new requests 72 for the encoded picture part streams 66 at different bitrates are received. The method generally finishes when a final requested part (chunk) of the video content item 10 has been streamed to the client device 38.

FIG. 9 is a flow chart showing exemplary steps in a method of operation of the client device 38 of FIG. 4 in accordance with the alternative embodiment of the present disclosure. Reference is also made to FIG. 4. The processor 50 of the client device 38 is operative to prepare the request 72 for the video content item 10. At this stage, as the client device 38 has not yet started rendering the video content item 10, the processor 50 is operative to select the bitrates for the encoded picture part streams 66 according to which encoded picture part streams 66 are generally more viewed by other client devices 38 or to select the bitrates for the encoded picture part streams 66 at the same bit rate which may be the lowest bitrate by way of example only. The interface 52 is operative to send the content request 72 to the server 36 (block 98). It will be appreciated that the content request 72 may be performed in one stage or two or more stages. For example, a general request for the video content item 10 may be directed to a request router, which redirects the client device 38 to an edge cache (not shown). The client device 38 sends the content request 72 to the edge cache and then receives one or more manifest files. The client device 38 then sends a request for the encoded picture part streams 66 listed in the manifest files to the edge cache.

The interface 52 of the client device 38 is operative to receive the chunks of the encoded picture part streams 66 and the media player 56 running on the processor 50 is operative to render the received chunks of the encoded picture part streams 66 (block 100).

The processor 50 is operative to process data about viewports generated during the rendering of the video content item 10 by the media player 56 of the client device 38 to yield a viewing rating for each at least one region of the pictures 30 of the video content item 10 of how much each at least one region has been rendered for viewing during rendering of the video content item 10 by the media player 56 of the client device 38 (block 102).

The processor 50 is operative to select different bitrates for streaming of a plurality of picture part streams 66 of the video content item 10 to the client device 38 based on: available bandwidth and optionally other factors (e.g., CPU and cache considerations); and the viewing rating(s) (based on historic data of how much the at least one region of a plurality of pictures of the video content item has been rendered for viewing during rendering of the video content item by the client device) (block 104). The method then loops back to the step of block 98 wherein the selected bitrate encoded picture part streams 66 are requested by the processor 50 preparing a new content request 72 to be sent by the interface 52. The interface 52 is operative to receive the different picture part streams 66 of the video content item 10 at the selected different bitrates. The method loops around the steps of blocks 98-104 until the requested blocks of the video content item 10 have been received and rendered.

In accordance with an alternative embodiment of the present disclosure, the selection of the different bitrates for streaming of the picture part streams 66 of the video content item 10 to the client device 38 may be enhanced based on machine learning techniques. For example, a viewing history of a video content item may provide the following data:
region X was been viewed for 2 minutes; followed by
region Y was been viewed for 3 minutes; followed by
region Z was been viewed for 3 minutes; followed by
region X was been viewed for 2 minutes; followed by
region Y was been viewed for 3 minutes; followed by
region Z was been viewed for 2 minutes.

Machine learning techniques may estimate that the next region to be viewed will be region X following the above pattern. Therefore, at present both regions X and Z will be selected for the highest bitrate and region Y for a lower bitrate.

In practice, some or all of the functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively or additionally, the software may be stored in tangible, non-transitory computer-readable storage media, such as optical, magnetic, or electronic memory.

It is appreciated that software components may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present disclosure.

It will be appreciated that various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

It will be appreciated by persons skilled in the art that the present disclosure is not limited by what has been particularly shown and described hereinabove. Rather the scope of the disclosure is defined by the appended claims and equivalents thereof.

1. A method comprising:
receiving a request for video content item comprising a plurality of successive pictures, each of the plurality of successive pictures comprising a plurality picture parts corresponding to a plurality of viewports;
selecting a first bitrate for streaming of a first picture part corresponding to a first viewport of a first picture of the video content item to a client device;
selecting a second bitrate for streaming of a second picture part corresponding to a second viewport of the first picture of the video content item, wherein the second bitrate is different from the first bitrate, wherein the first bitrate and the second bitrate are selected based on available bandwidth and historic data comprising a render time for each of the plurality of viewports of the video content item during rendering of the video content item by the client device, wherein a first render time for the first picture part is different than a second render time for the second picture part and wherein each of the first picture part and the second picture part is encoded at a plurality of bitrates; and
providing the video content item comprising the first picture part at the first bitrate and the second picture part at the second bitrate.

2. The method according to claim 1, further comprising receiving feedback data from the client device rendering the video content item, the feedback data comprising a viewing rating for each of the first picture part and the second picture, the viewing rating comprising an amount of time each of the first picture part and the second picture part has been rendered for viewing during rendering of the video content item.

3. The method according to claim 2, further comprising streaming a plurality of picture part streams of the video content item at a selected different bitrates to the client device.

4. The method according to claim 2, wherein the viewing rating each of the first picture part and the second picture part is assigned from a selection of a plurality of viewing ratings based on whether viewing of the first picture part and the second picture part has exceeded a plurality of predefined viewing targets.

5. The method according to claim 1, further comprising:
processing data about the plurality of viewports generated during the rendering of the video content item to yield a viewing rating for each of at least one region of how much each the at least one region has been rendered for viewing during rendering of the video content item by the client device, the plurality of viewports corresponding to the at least one region; and
streaming the plurality of different picture part streams of the video content item at the selected different bitrates.

6. The method according to claim 5, wherein the viewing rating of the at least one region is assigned from a selection of a plurality of viewing ratings based on whether or not the viewing of the at least one region has exceeded a plurality of predefined viewing targets.

7. The method according to claim 1, wherein the video content item is a panoramic video.

8. The method according to claim 1, wherein a plurality of different bitrates are selected for streaming of a plurality of picture part streams so that higher bitrates are selected for higher viewed streams of the plurality of picture part streams during rendering of the video content item by the client device.

9. A system comprising a processor and a memory to store data used by the processor, the processor being operative to:
receive a request for video content item comprising a plurality of successive pictures, each of the plurality of successive pictures comprising a plurality picture parts corresponding to a plurality of viewports;
select a first bitrate for streaming of a first picture part corresponding to a first viewport of a first picture of the video content item to a client device;
select a second bitrate for streaming of a second picture part corresponding to a second viewport of the first picture of the video content item, wherein the second bitrate is different from the first bitrate, wherein the first bitrate and the second bitrate are selected based on available bandwidth and historic data comprising a render time for each of the plurality of viewports of the video content item during rendering of the video content item by the client device, wherein a first render time for the first picture part is different than a second render time for the second picture part and wherein each of the first picture part and the second picture part is encoded at a plurality of bitrates; and
providing the video content item comprising the first picture part at the first bitrate and the second picture part at the second bitrate.

10. The system according to claim 9, wherein the processor is further operative to:
receive feedback data from the client device rendering the video content item, the feedback data comprising data about the plurality of viewports generated during the rendering of the video content item the feedback data comprising a viewing rating for each of the first picture part and the second picture part the viewing rating comprising an amount of time each of the first picture part and the second picture part has been rendered for viewing during rendering of the video content item.

11. The system according to claim 10, wherein the processor is further operative to stream a plurality of picture part streams of the video content item at the selected different bitrates to the client device.

12. The system according to claim 10, wherein the viewing rating is assigned from a selection of a plurality of viewing ratings based on whether a viewing of each of the first picture part and the second picture part has exceeded a plurality of predefined viewing targets.

13. The system according to claim 9, wherein the processor is further operative to:
process data about the plurality of viewports generated during the rendering of the video content item to yield a viewing rating for each of at least one region of how much each at least one region has been rendered for viewing during rendering of the video content item, the plurality of viewports corresponding to the at least one region;
the plurality of different picture part streams of the video content item at the selected different bitrates.

14. The system according to claim 13, wherein the viewing rating of each of the first picture part and the second picture part is assigned from a selection of a plurality of viewing ratings based on whether viewing of each of the first picture part and the second picture part has exceeded a plurality of predefined viewing targets.

15. The system according to claim 13, wherein the viewing rating for each of the first picture part and the second picture part is based on how much each of the first picture part and the second picture part has been rendered for viewing during a pre-defined duration time period during rendering of the video content item by the client device.

16. The system according to claim 9, wherein the video content item is a panoramic video.

17. The system according to claim 16, wherein each of the plurality of successive pictures is comprised in a video frame formatted as an equirectangular representation or a cubemap representation.

18. The system according to claim 9, wherein each the first picture part and the second picture part is from a different camera view captured during filming of the video content item.

19. The system according to claim 9, wherein the processor is operative to select a plurality of different bitrates for streaming of a plurality of picture part streams so that higher bitrates are selected for higher viewed streams of the plurality of picture part streams during rendering of the video content item by the client device.

20. A non-transitory computer-readable medium that stores a set of instructions are stored, which instructions, when read by a processing unit, cause the processing unit to;
receive a request for video content item comprising a plurality of successive pictures, each of the plurality of successive pictures comprising a plurality picture parts corresponding to a plurality of viewports;
select a first bitrate for streaming of a first picture part corresponding to a first viewport of a first picture of the video content item to a client device;
select a second bitrate for streaming of a second picture part corresponding to a second viewport of the first picture of the video content item, wherein the second bitrate is different from the first bitrate, wherein the first bitrate and the second bitrate are selected based on available bandwidth and historic data comprising a render time for each of the plurality of viewports of the video content item during rendering of the video content item by the client device, wherein a first render time for the first picture part is different than a second render time for the second picture part and wherein each of the first picture part and the second picture part is encoded at a plurality of bitrates; and
providing the video content item comprising the first picture part at the first bitrate and the second picture part at the second bitrate.
